(19) United States
(12) Patent Application Publication
(10) Pub. No.: US 2004/0086716 A1
(43) Pub. Date: May 6, 2004

(54) Glass pane

(76) Inventor: Josef Weikinger, Mauren (CH)

Correspondence Address: NIXON & VANDERHYE, PC, 1100 N GLEBE ROAD, 8TH FLOOR, ARLINGTON, VA, 22201-4714, US

(21) Appl. No.: 10/471,764

(22) PCT Filed: Aug. 7, 2001
(86) PCT No.: PCT/CH01/00480

(30) Foreign Application Priority Data
Feb. 15, 2001 (CH) 268/01
Apr. 20, 2001 (CH) 721/01

(51) Int. Cl. B32B 17/00

(52) U.S. Cl. 428/410

(57) ABSTRACT

The invention relates to a glass pane that is particularly suitable for solar applications such as photovoltaic and thermal cells. The glass pane disclosed in the invention has a microstructure on both sides that can be produced, for instance, by embossing with roll embossing. Microsuructures with a maximum peak-to-valley ratio of not more than 50 mm and preferably not more than 30 have visible light transmittance values close to those of non-structured glass. An additional improvement in transmittance properties can be achieved by placing an anti-glare layer on the glass pane.

The invention relates to a glass pane, in particular for use in solar applications

In solar cells for photovoltaics (conversion of sun energy into electricity) as well as in thermal solar cells for obtaining heat energy by way of heat exchangers one uses high-quality glasses with a high transmission for the solar irradiation. Glass panes are used in solar cells as substrates for the semiconductor layers which are responsible for the conversion of light energy into current. Thermal solar cells consist essentially of a flat heat exchanger which is arranged behind a glass pane. The glass pane thermally insulates the heat exchanger with respect to the surrounding air so that as little as possible of the captured sun irradiation is emitted again to the surroundings.

Thermal as well as photovoltaic solar cells have a great space requirement since the extraction of energy depends directly on the irradiated area. Solar glasses arranged on roofs of houses or on facades should let through as much solar irradiation as possible and reflect as little as possible. The reflection of irradiation is not only undesirable with regard to energy considerations, but also because the reflecting glass surfaces in residential areas may disturb neighbours or traffic. To avoid this problem glass panes are applied in solar cells which are matt on the one side. Matt glass panes also have the advantage that dirt accumulation is not perceived so much.

There are known glass panes with a microstructure on one side. Such matt glass panes are manufactured in that the glass drawn from glass molten mass is embossed with a roller, i.e. is provided with a microstructure. These glass panes have the disadvantage that the permeability to the solar irradiation is often significantly reduced depending on the angle of incidence. A further disadvantage is the fact that glass panes embossed on one side are often wrongly installed, i.e. the matt glass surfaces for example are arranged on the side of the heat exchanger instead of on the side of the surroundings. However the transmission and reflection qualities are reduced due to the incorrect installation of the glass panes.

It is the object of the present invention to provide an improved glass or glass pane for solar applications. The glass panes should have as large as possible transmission and as low as possible reflection to the solar irradiation. The danger of the glass panes being incorrectly installed is also to be reduced.

According to the invention this object is achieved in that the glass surface is embossed on both sides, i.e. comprises a microstructure. The advantage of a glass pane which on both glass surfaces comprises a three-dimensional microstructure or relief lies in the fact that the glass may be installed in solar cells with any orientation. Glasses structurised on both sides surprisingly have a transmission power which corresponds to or is superior than that of glass panes structured on one side.

Usefully the microstructure may be manufactured by embossing the glass drawn from a molten mass with rollers which have a microstructure and are arranged lying opposite one another so that with the passage of the glass panes which are still deformable one may impress complementary microstructures into the glass surfaces. This is an inexpensive manufacturing process. Claim 14 relates to this manufacturing process.

According to a preferred embodiment the microstructures embossed into the glass surfaces have a height difference between projection and recess (peak to valley) of maximal 50 μm, preferably maximal 30 μm. Trials have shown that relief-like structures formed in such a manner ensure a high transmission capability of the glasses. A further advantage of such glass panes comprising microstructures is that the angular factor, i.e. the ratio of the solar transmittance with a variable angle of incidence relative to perpendicular incidence is close to the angular factor of non-structurised glass. Particularly preferred microstructures describe a cosinusoidal, Gaussian or cone function. These structures have a very good angle-dependent transmission behaviour. A further advantage is the fact that it is of practically no significance whether the structures are male or female. Further useful microstructures are pyramidal with a trigonal, square or hexagonal base, cone-shaped, hemispheres or ball sections seated on the glass surface.

The ratio of structure height to structure width is preferably maximally 50 μm/800 μm, preferably 30 μm/800 μm and very particularly preferred 20 μm/800 μm. These glass panes have the greatest transmission power. It is also significant for the transmission power that the glass of the glass panes has an iron content of less that 0.05 percent by weight of iron oxide, preferably less than 0.03 percent by weight of iron oxide. It is also advantageous for the glass of the glass panes to have essentially no chromium oxide (Cr₂O₃).

The microstructures may be designed such that they project out of the glass, i.e. are male, or are impressed into the glass, i.e. are female. Both embodiment forms are suitable for solar applications.

The subject-matter of the present invention is also a glass pane with at least one microstructure on one side of the glass pane, wherein the microstructure consists of projections and recesses lying therebetween, has a height difference between projection and recess (peak to valley) of maximal 50 μm, preferably maximal 30 μm and very particularly preferred maximal 20 μm and further an antireflex layer is deposited onto the glass pane. The antireflex layer may in principle be deposited onto the microstructure or onto the distant smooth glass surface. By way of the antireflex layer the transmission may also be 100%. The antireflex layer may be manufactured by way of known additive or subtractive manufacturing processes. For example the treatment of the glass surface with an acid solution (also buffered acid solution) and the exposure of the glass surface to high-energy particles belong to the subtractive manufacturing processes.

The antireflex layer may be single-layered or multi-layered and is preferably obtainable by way of the sol-gel method, embossing method, spray coating, evaporisation or sputtering. An overview of sol-gel technology is made by D. R. Uhlmann, T. Suratwala, K. Davidson, J. M. Boulton, G. Teowee in J. Non-Cryst. Solids 218 (1997) 113.

According to a preferred embodiment form the antireflex layer is a porous polymer layer obtainable by depositing a solution of at least two different polymeric compounds with different dissolution properties, forming a polymer layer by evaporating the solvent and the subsequent at least part removal of at least one polymeric compound by contacting and dissolving with a further solvent. By way of this method one may obtain a porous polymer layer with pores whose dimension is smaller than the wavelength of visible light. The refractive index of porous layers corresponds to the average of the refractive indices of the deposited material and air. By way of varying the porosity one may set the refractive index in a targeted manner. At the same time one may also achieve very small refractive indices which may not be manufactured with conventional materials, e.g. MgF₂. By way of example porous antireflex layers can be manufactured by a sol-gel-method or by embossing. Porous antireflex layers are basically also obtainable by mixture of the following plastics: polymethacrylate, polymethylmethacrylate, polystyrol, polyacrylate, polyvinyl chloride, polyvinyl pyridine, polycarbonate, polycarbonate compounds and others. With the manufacture of porous polymer antireflex layers it is significant that the applied polymer compounds have different dissolution properties so that a polymer compound is preferably dissolved in a certain solvent. Furthermore the average molecular weight of the applied polymer compounds is to be selected such that one achieves the desired pore size and dissolution properties. It is assumed that on evaporation of the solvent a part de-mixing of the polymer compounds takes place so that there arise laterally alternating regions of the different polymer compounds. By way of at least partly dissolving out one of the polymers there result pores which may be smaller than the wavelength of visible light.

The polymer compounds may basically be deposited onto the glass surface by immersing into a solution containing the polymer compounds or by way of spin-coating. It is also conceivable to manufacture the porous surfaces by embossing, in that the porous nanostructure is etched into the embossing rollers.

For applications in solar technology the glass pane on the outside may comprise an antireflex layer and the glass surface distant to this may comprise a microstructure. In this manner, on the outside one has an outer surface which may be easily cleaned and furthermore on account of the antireflex layer and the microstructure, a glass pane with a very high degree of transmission to visible light.

The invention is described in more detail with regard to the figures. There are shown in:

FIG. 1: a diagram in which the angular factor of a known glass structured on one side with a roughness depth of 90 μm (peak to valley) is represented as a function of the angle of incidence;

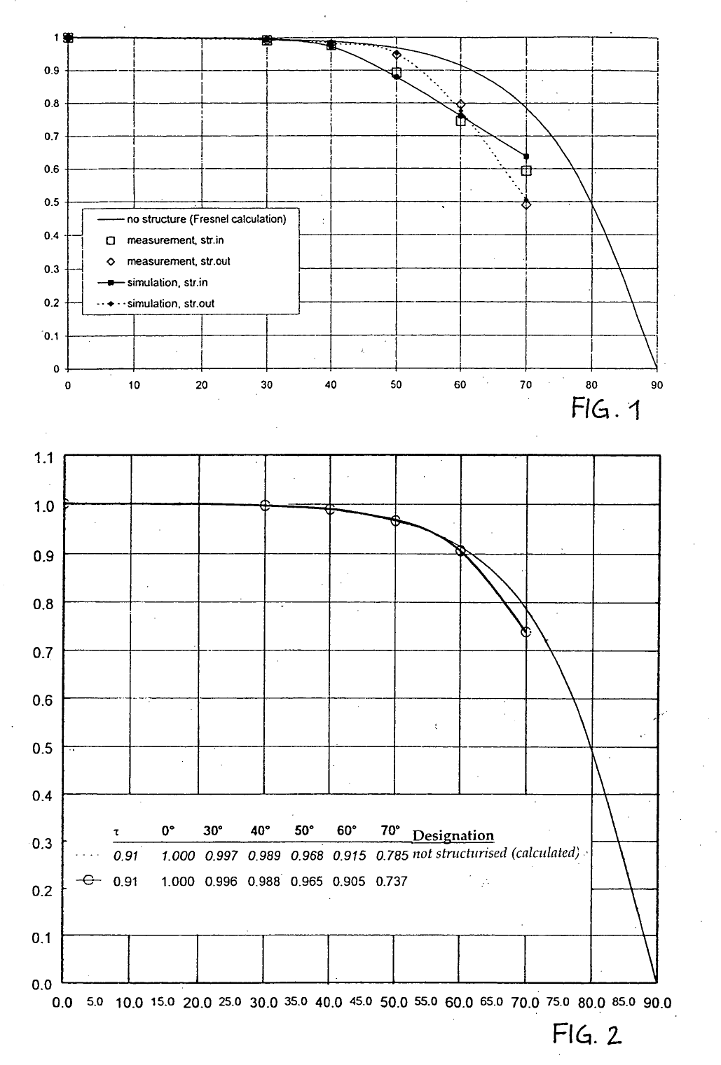

FIG. 2: a diagram in which the angular factor of a glass according to the invention structured on both sides is represented as a function of the angle of incidence;

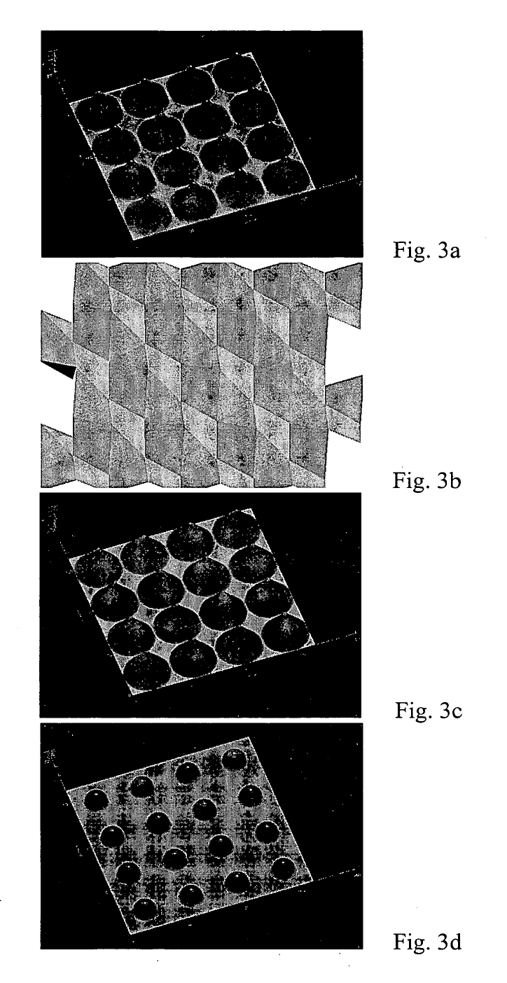

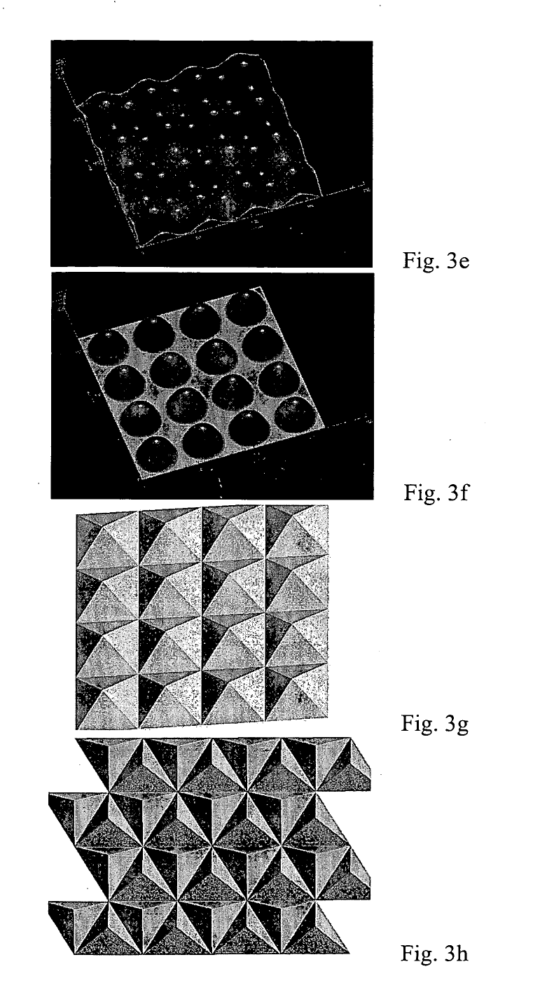

FIG. 3: examples of different examined surface structures;

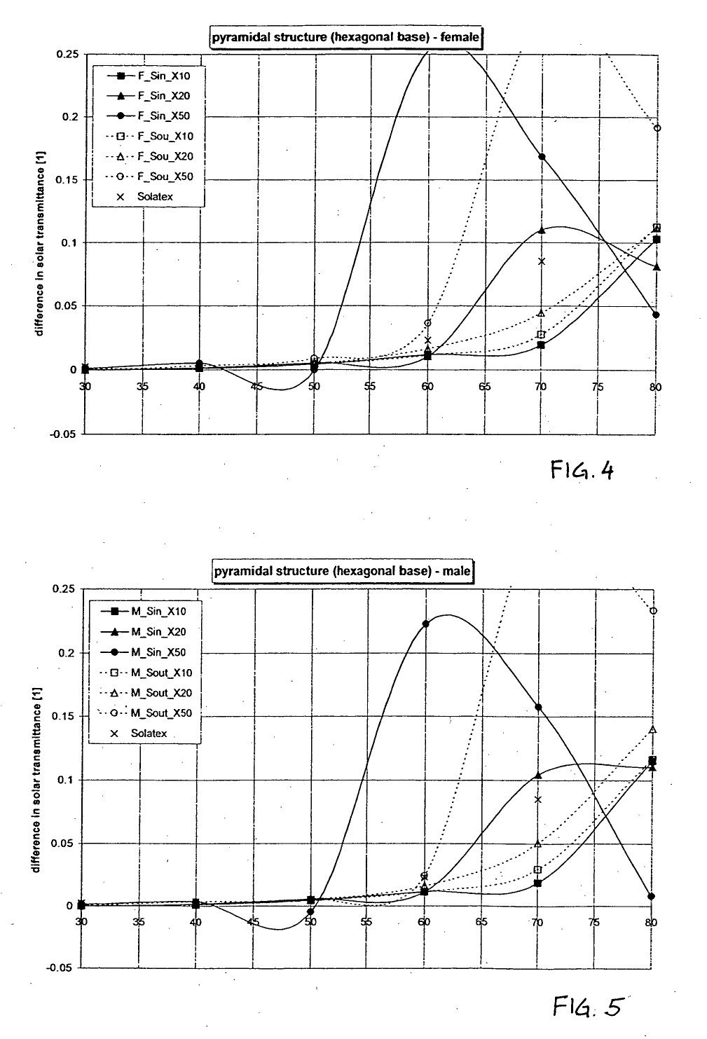

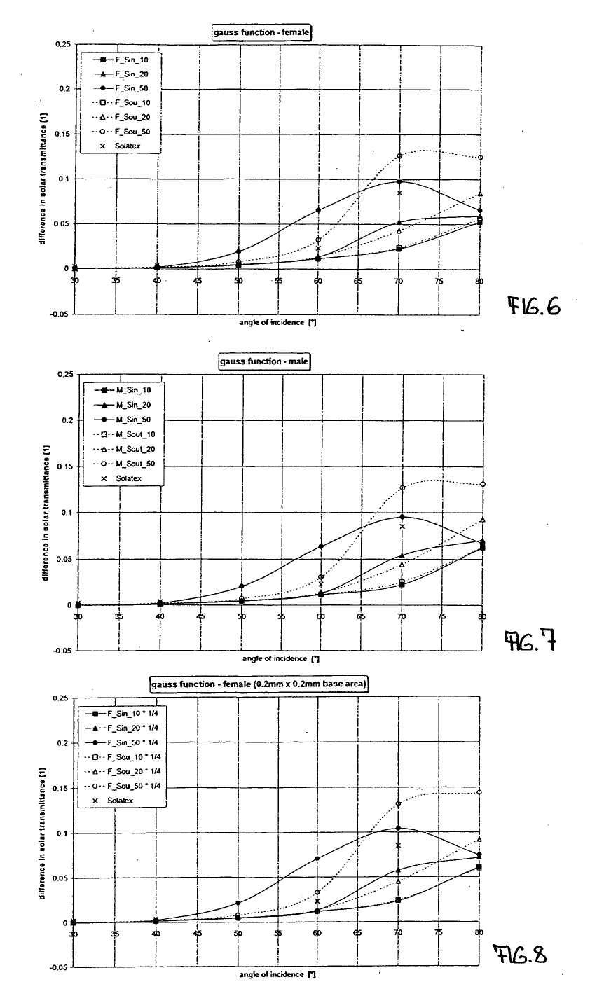

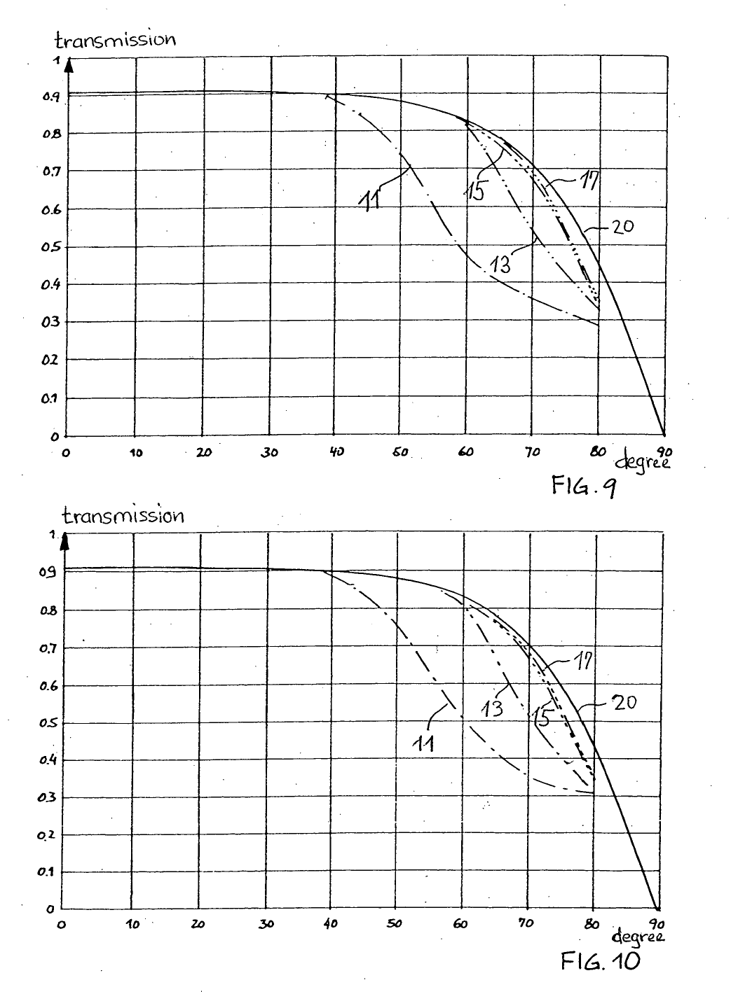

FIG. 4: a diagram in which the relative solar transmission power of a microstructure between 10 m and 50 m in height which in section is female and cosinusoidal is plotted as a function of the angle of incidence;

FIG. 5: a diagram in which the relative solar transmission power of a microstructure between 10 m and 50 m in height which in section is male and cosinusoidal is plotted as a function of the angle of incidence;

FIG. 6: a diagram in which the relative solar transmission power of a microstructure between 10 m and 50 m in height which in section is female and Gaussian is plotted as a function of the angle of incidence;

FIG. 7: a diagram in which the relative solar transmission power of a male microstructure between 10 m and 50 m in height which in section is pyramidal is plotted as a function of the angle of incidence;

FIG. 8 the transmission values of a microstructure which is Gaussian in section and which faces the illumination, as a function of the angle of incidence;

FIG. 9 the transmission values of a microstructure which is Gaussian in section and which is distant to the illumination, as a function of the angle of incidence;

The FIGS. 1 and 2 show diagrams in which the angular factor of a known glass structurised on one side (FIG. 1) and a glass structurised on both sides (FIG. 2) is represented as a function of the angle of incidence. Angular factor is to be understood by definition as the ratio of the solar transmission degree at a variable angle of incidence relative to a perpendicular incidence. Unstructurised (smooth) glasses have the highest angular factor. For purposes of comparison the angular factors of an unstructurised glass is drawn into the figures in each case as a reference curve. The measured glasses all have a thickness of 3.2 or 4 mm.

The known glass with a roughness depth of 90 μm was measured, once with the structurised side distant to the light source (thus with a collector directed to the inner side=“str. in) or facing the light source (“str. out”). It is evident that the angular factors may vary up to 10% according to the angle of incidence. Whilst an outwardly directed structure (facing the light source) up to an angle of incidence of 60° is better than an inwardly directed structure, the latter has been shown to be the better one with an angle of incidence between 60 and 70 degrees.

The glass according to the invention with a surface structure on both sides of 30 μm (peak to valley) has been surprisingly shown to be the better glass. Even with an angle of incidence of 70 degrees the angular factors is only insignificantly worse than the angular factor of an unstructurised glass. In comparison to the known glass of FIG. 1 with all angles of incidence one achieves higher transmission values. From this there results the considerable advantage that in contrast to glasses structurised on one side, the orientation of the structurised surface is not significant.

FIGS. 3a to 3h show different possible geometric surfaces structures. These structures are theoretically accessible to simulation computations (e.g. OptiCAD). At the same time the structure projections (peak to valley) may be varied and the influence on the transmission power may be determined.

FIG. 3a shows a structure which in section has a Gaussian function. The height z is composed of the product of the Gaussian functions for the location (x, y) at a distance of 800 μm to one another.

FIG. 3b shows a pyramidal structure with a hexagonal base. The pyramids project out of the glass surface (male structure). In the x-direction (horizontal transverse axis) the distance is 693 μm, in the y-direction 600 μm.

FIG. 3c shows a cone-shaped structure which is formed by cones seated on the glass. The cone base surface has a diameter of 800 μm and a distance of 800 μm to one another.

FIG. 3d shows a structure with hemispheres seated on the glass. The hemispheres have a diameter of 200 μm and are arranged at a distance of 800 μm.

FIG. 3e shows a structure which in section is a cosinusoidal function in the direction x and y. The structure has a period of 800 μm.

FIG. 3f shows a structure with ball sections (male) which are arranged at regular distances on the glass. The diameter of the balls is 800 μm. The ball sections are 100 μm, 200 μm or 400 μm high (hemisphere).

FIG. 3g shows a male, pyramidal structure. The pyramids are 4-sided and have a square base surface of 800 μm edge length.

FIG. 3h likewise shows a male, pyramidal structure but with a trigonal base. The side length of the base surface is 800 μm. The x-direction (transverse axis) is horizontal.

In the FIGS. 6 to 8 there is represented the difference in the solar transmission as a function of the angle of incidence for a microstructure which in section is Gaussian with a 800 μm×800 μm base surface. The difference of the solar transmission corresponds to the transmission of the observed microstructure minus the transmission of a non-structurised glass. By way of this manner of representation one achieves a spreading of the y-axis.

FIG. 6 shows a female microstructure, with which the Gauss-shaped microstructures are impressed into the glass surface. FIG. 7 shows a male microstructure with which the Gauss-shaped microstructures project out of the glass surface. A comparison of the curves shows that the female and male microstructures with regard to transmission behaviour have practically the same properties. It may further be recognised from the figures that the microstructures with a peak to valley ratio of 50:1 at angles of incidence of greater than 40 degrees have the worse transmission values. The microstructures in size may be scaled over a certain range. Thus the transmission values of a Gauss-shaped microstructure with a base of only 200 μm×200 μm (FIG. 8) are practically equal to the transmission values of a microstructure with a base of 800 μm×800 μm.

FIGS. 9 and 10 show the influence of the height of cone-shaped projections/microstructure on the transmission (ordinates) at different angles of incidence (abscissas). In FIG. 9 the cone-shaped microstructures face the illumination (structure out), in FIG. 10 are distant to the illumination (structure in). The curves 11, 13, 15 and 17 correspond to microstructure heights of 200 μm, 50 μm, 20 μm and 10 μm. Curve 21 corresponds to a glass with a non-structurised (smooth) glass surface. It is to be deduced from the representations that a microstructure of 50 μm height has a considerably greater transmission at larger angles of incidence than a structure with 200 μm height. If the microstructures have a height of less than 30 μm, then the transmission values differ only very little.

A further improvement of the transmission degree may be achieved if, as described above, an antireflex layer is additionally deposited onto the glass pane or is formed in the glass surface.

The glass pane according to the invention for solar applications with two parallel surfaces lying opposite one another comprises microstructures on both glass surfaces. The microstructures ensure a matt appearance of the glass surfaces. The microstructures are regularly or irregularly arranged projections and recesses with a peak-to valley ratio of max. 50 μm, preferably max. 30 μm and very particularly preferred max. 20 μm. According to another aspect of the invention the microstructure may be covered over with an antireflex layer. The antireflex layer is preferably a porous polymer layer.

on the glass surface

1. A glass pane with a microstructurised glass surface, in particular for solar applications, characterised in that both glass surfaces comprise a microstructure.

2. A glass pane according to claim 1, characterised in that the microstructure can be manufactured by embossing a glass which is drawn from the molten mass by way of rollers arranged lying opposite one another and having a microstructure.

3. A glass pane according to claim 1 or 2, characterised in that the microstructure of the glass surfaces have a height difference between projection and recess (peak to valley) of maximal 50 μm, preferably maximal 30 μm and very particularly preferred 20 μm.

4. A glass pane according to one of the claims 1 to 3, characterised in that the microstructures in section describes a cosine, Gaussian or conical function.

5. A glass pane according to one of the claims 1 to 3, characterised in that the microstructures are pyramidal with a trigonal, square, or hexagonal base, are conical, are hemispheres or are ball sections seated on the glass surface.

6. A glass pane according to one of the claims 1 to 5, characterised in that the ratio of structure height to structure width is maximal 50 μm/800 μm, preferably 30 μm/800 μm and very particularly preferred 20 μm/800 μm.

7. A glass pane according to one of the claims 1 to 6, characterised in that the glass of the glass panes has an iron content of less than 0.05 percent by weight, preferably less than 0.03 percent by weight.

8. A glass pane according to one of the claims 1 to 7, characterised in that the glass of the glass panes essentially comprises no chromium oxide (Cr₂O₃).

9. A glass pane according to one of the claims 1 to 8, characterised in that the microstructures project out of the glass, i.e. are male.

10. A glass pane according to one of the claims 1 to 8, characterised in that the microstructures are pressed into the glass, i.e. are female.

11. A glass pane according to one of the claims 1 to 8, characterised in that the microstructures in the two glass surfaces are formed differently.

12. A glass pane according to claim 11, characterised in that an antireflex layer is deposited on the microstructure.

13. A glass pane according to claim 12, characterised in that the antireflex layer is produced by a sol-gel-method, embossing, evaporation or sputtering.

14. A glass pane according to claim 12, characterised in that the anitireflex layer is a polymer layer.

15. A glass pane according to claim 14, characterised in that a polymer layer is brought onto the glass pane by way of depositing a solution of at least two different polymeric compounds with different dissolution properties, forming a polymer layer by evaporating the solvent and subsequently at least partly removing a polymeric compound by contacting and dissolving with a further solvent.

16. A glass pane with at least one microstructure on one side of the glass pane, characterised in that the microstructure consists of projections and recesses lying therebetween, has a height difference between projection and recess (peak to valley) of maximal 50 μm, preferably maximal 30 μm and very particularly preferred maximal 20 μm and further an antireflex layer is deposited onto the glass pane.

17. A glass pane according to claim 16, characterised in that the antireflex layer is deposited on the microstructure.

18. A glass pane according to claim 15 or 16, characterised in that the polymer layer is brought onto the glass pane by way of depositing a solution of at least two different polymeric compounds with different dissolution properties, forming a polymer layer by evaporating the solvent and subsequently at least partly removing a polymeric compound by contacting and dissolving with a further solvent.

19. A glass pane according to one of the claims 16 to 18 and one of the claims 2 to 14.
